(19) United States
(12) Patent Application Publication
(10) Pub. No.: US 2020/0107672 A1
(43) Pub. Date: Apr. 9, 2020

(54) COFFEE ROASTER AND DEGASSER

(71) Applicant: Steve CHA, Franklin Lakes, NJ (US)

(72) Inventor: Steve CHA, Franklin Lakes, NJ (US)

(21) Appl. No.: 16/596,909

(22) Filed: Oct. 9, 2019

Related U.S. Application Data
(60) Provisional application No. 62/743,160, filed on Oct. 9, 2018.

(51) Int. Cl. A47J 31/42; A23N 12/08; A23N 12/12; A23F 5/10; A23F 5/08; A23F 5/04; A23F 5/26

(52) U.S. Cl. CPC A47J 31/42; A23N 12/083; A23N 12/125; A23N 12/086; A23F 5/08; A23F 5/046; A23F 5/26; A23F 5/105

(57) ABSTRACT

A method and system for preparing coffee includes roasting green coffee beans, thereby resulting in roasted coffee beans; grinding the roasted coffee beans, thereby resulting ground coffee; and degassing carbon dioxide from the ground coffee.

### BACKGROUND

Over 2 billion cups of coffee are consumed world-wide, every day. Coffee is a drink that is brewed from coffee beans, which are the seeds of the coffee tree. A coffee tree grows a fruit known as coffee cherries which contain coffee beans. Removing the pulp of the coffee cherries, drying, fermenting, and milling results in what is commonly referred to as the “green coffee bean.” The green coffee bean is dry, rough to the touch, and capable of being stored for later use.

Green coffee beans are then roasted, and grounded before brewing. Brewing with whole beans taste better and last longer when compared to pre-ground coffee as later can grow stale. However, commercially roasted coffee beans are considerably more expensive than green coffee beans. Further, commercially brewed whole beans will grow stale if they are kept in your pantry over a period of time. Consumers generally buy roasted coffee or pre-grounded coffee, and the unfortunate truth is that they are unused for a lengthy period of time, causing them to go stale due to moisture, oxidation, and carbon dioxide depletion. For these reasons, many choose to brew the green coffee beans at home for better taste and freshness.

When coffee is roasted, CO2 gas formed inside the bean can affect the flavor of your coffee. For better taste, degassing of CO2 gas is required for a several days prior to brewing. This degassing process is the reason roasters start selling their coffee a few days after the roast date, and coffee is at its best when made from beans roasted no more than two weeks ago. Unfortunately, commercially roasted whole bean starts to lose flavor in a few days, and retails stores are frequently selling bags of roasted beans that are more than 2 weeks ago. Unlike milk, which goes bad within a few weeks, green coffee beans seems to have a longer shelf life. However, there is a significant difference in taste between fresh roasted beans a few days old and those roasted beans that are one month old.

Degassing can vary depending on the type of coffee and roast. Thus, it may take from 2-12 days until the coffee is ready to brew for best tasting coffee. However, the purchased roasted coffee beans have to be consumed within a short amount of time as oxygen starts to make its way into your beans which in turn cause the staleness. Additionally, when the consumer purchases roasted coffee beans, the consumer no longer controls the flavor.

Fresh roasted coffee beans are better in taste and quality of your coffee can be improved by brewing your own coffee using your own freshly ground beans. Accordingly, there is a need for a single convenient system that can roast, degass and brew so that a user has more control over the brewing process to fit one's taste and brewing method preferences.

Further limitations and disadvantages of convention and traditional approaches will become apparent to one of skill in the art, through comparison of such systems with embodiments of the present invention as set forth in the remainder of the present application with reference to the drawings.

### SUMMARY

Other aspects, advantages, and salient features of the invention will become apparent to those skilled in the art from the following detailed description, which, taken in conjunction with the annexed drawings, discloses exemplary embodiments of the invention.

One aspect of invention is to provide a single coffee system where roasting, degassing, and brewing can be achieved such that a fresh coffee can be brewed for a better and fresh taste.

Another aspect of invention is to provide an economical coffee system by offering roasted beans at home, office or at your own venue by eliminating the need to purchase the roasted bean from a third party roaster.

Another aspect of invention is to provide a single coffee system which enable a user to selectively adjust the roasting time and/or degassing duration to accommodate each user's preference.

Another aspect of invention is to provide an automatic roasting system that is fast and easy in which the coffee beans are roasted to one's preference for fresh and flavorful coffee.

Another aspect of invention is to provide more coffee options where users can select and combine different whole bean types and apply different roasting styles to obtain unique blends for themselves.

Another aspect of invention is to provide an automatic coffee maker that allows to adjust time, temperature, and fan speed during roasting procedure, and to enable to selectively save and change the roasting preferences for subsequent roasting.

A further aspect of invention is to provide more coffee options where users can select and combine different whole bean types and apply different roasting styles to obtain unique blends for themselves.

Yet, a further aspect of invention is to shorten the lengthy degassing process that last a few days into a few minutes such that all in one system can provide an automatic roasting, degassing and brewing that is easy and fast for fresh and flavorful coffee at home, office, or any venue.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a block diagram of a coffee roaster and degasser according to an embodiment of present invention;

FIG. 2 illustrates a detailed diagram of coffee roaster according to an embodiment of present invention;

FIG. 3 illustrates a block diagram of a coffee roaster and degasser according to another embodiment of present invention;

FIG. 4 illustrates a detailed diagram of vacuum operation according to an embodiment of present invention;

FIG. 5 illustrates a block diagram of a degasser according to another embodiment of present invention; and

FIG. 6 illustrates a flow chart illustrating the operations of coffee roaster and degasser according to an embodiment of present invention.

### DETAILED DESCRIPTION

The following description describes certain embodiments. The following discussion shall be understood to be only for the purpose of enabling a person of ordinary skill in the art to make and use the subject matter of any claims that are presently pending or may later be added, or which may issue in any patent. It shall be understood that the following embodiments are not limiting and nothing is essential or critical unless specifically designated.

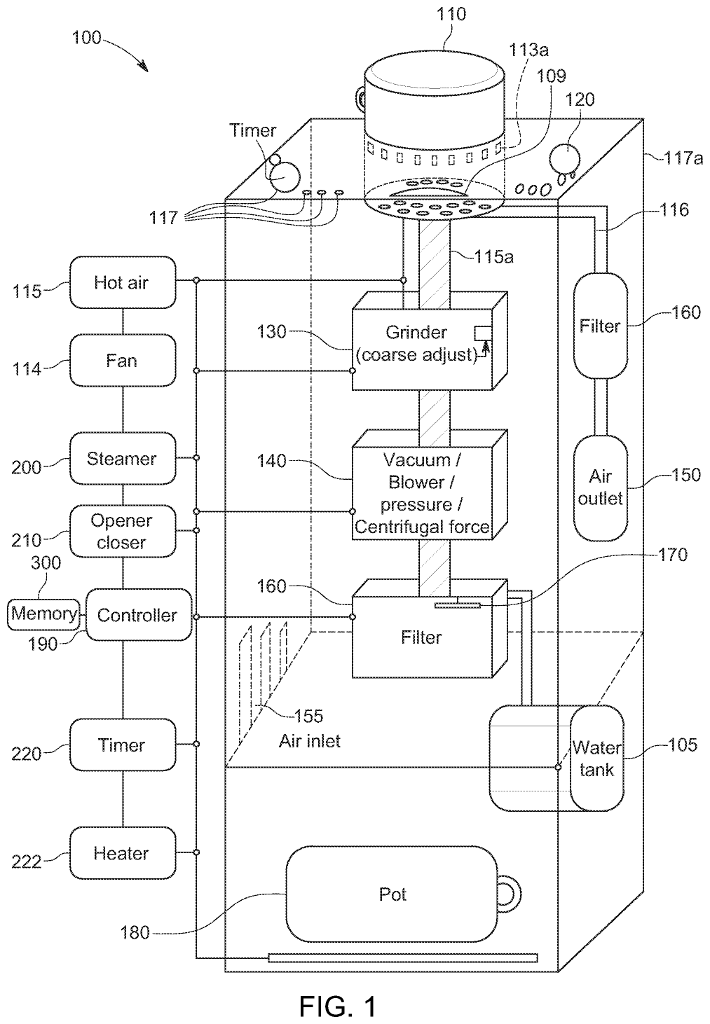

Referring to FIG. 1, there is illustrated a block diagram of an exemplary coffee roaster and degasser 100. The coffee roaster and degasser 100 comprises a housing with a water tank 105, a roaster/cooler 110, a tunnel 115a, a water inlet 120, a grinder 130, and a degassing stage which can comprise a vacuum-capable chamber 140, an air outlet 150, a filter 160, a bloomer 170 and a pot 180. In another embodiment, a rotating stir mixer 109 can be provided to stir and channel the roasted beans to exit to a next stage. The water tank 105 receives water through the water inlet 120. The roaster 110 receives and roasts green coffee beans, resulting in roasted coffee beans. In certain embodiments, the roaster 110 can both roast the green coffee beans and cool the roasted coffee beans. In the foregoing case, the cooler can be omitted, and the roasted coffee beans can enter the grinder 130 directly from the exit chute.

In certain embodiments, the roaster/cooler 110 can also cool the roasted coffee beans. After roasting, the roaster/cooler 110 cools the roasted coffee beans from a roasting temperature to a near room temperature. Note that the grinder 130 can fail when roasting hot freshly roasted beans, causing the steel burrs of the grinder 130 to absorb the heat and unnecessarily wear down.

In other embodiments, the roaster/cooler 110 can be implemented as a separate unit so that the roasting can be achieved in one container and the cooling can be achieved in another container. In this embodiment, the roaster 110 can drop the roasted coffee beans into a separate cooler located directly below or adjacent thereto. A tunnel can be provided to transfer the roasted coffee beans to the grinder 130.

The grinder 130 grinds the roasted coffee beans into ground coffee. It should be noted that many commercially available grinder can be implemented, for example, a blade grinder, a burr grinder, etc. The grind size can be adjusted using a button 117a so that the user can control optimal grind sizes to improve the flavor when brewing. The vacuum-capable chamber 140 receives the ground coffee in a vacuum chamber. In certain embodiments, a vacuum pump can remove air from the vacuum chamber with the ground coffee disposed, therein.

Note that when the roasted coffee is grounded, degassing significantly speeds up. The finer the grind, the larger the gas volume is released as the more cells that store CO2 gases are broken up and released. When the grounded coffee is in a vacuum chamber, according to one embodiment, vacuuming will place the ground beans in a negative-pressure environment to promote movement of gases. After undergoing the vacuum process, the grounded coffee are ready for brewing.

In another embodiment, when the ground coffee is in a vacuum chamber, the vacuum 140 may be configured to increase the vacuum and decrease the vacuum at constant or variable intervals. As gases flow due to a pressure differential, increasing and decreasing vacuum would have a pumping effect on the ground coffee which would promote the movement of gases out of the ground coffee. Thus, degassing can be enhanced by modifying the negative-pressure gradient when vacuuming the ground coffee in the vacuum 140.

Further, while the ground coffee undergoes the vacuum process as described above, a steam can be applied to increase oxidation according to an embodiment. All chemical reactions have higher reaction at higher temperatures. Thus, a combination use of steam and the use of vacuum would remove the volatile components in coffee, thus the ground coffee degassed at an enhanced rate according to the teachings of present invention.

The vacuum-capable chamber 140 may be implemented as to incorporate other types of treatment of the ground coffee. In certain embodiments, the vacuum-capable chamber 140 may be equipped with a centrifuge in order to spin the coffee grounds at high speeds, which may aid degassing in combination with the application of steam, and/or vacuum. The vacuum-capable chamber 140 may be equipped with a blower in order to introduce the movement of air over the ground coffee, with may aid degassing in combination with one or more of the application of steam, vacuum, and/or centrifugal spinning. The vacuum-capable chamber 140 may be implemented as to withstand pressure, and be equipped with an air pressurizer to generate positive pressure within the vacuum-capable chamber. Application of positive-pressure to the ground coffee may aid degassing in combination and/or sequence with one or more of the application of steam, vacuum, centrifugal spinning and positive pressure. It is understood any combination or sub-combination of these processes may be utilized, and any sequence of the combination or sub-combination may be utilized in order to achieve the desired result.

After vacuuming, the filter 160 receives the coffee grounds from the vacuum-capable chamber 140. The filter 160 can be implemented with a bloomer 170. The coffee grounds after degassing are further exposed to a bloom procedure in which CO2 chemicals are discharged by applying hot water via the bloomer 170 within the filter 160. In certain embodiments, the bloomer 170 uniformly infuses an amount of water from the water tank 105, causing the coffee grounds to bloom. When hot water touches the coffee grounds within the filter 160, the remaining trapped CO2 gases are further discharged. In certain embodiments, such as an espresso maker, the bloomer infuses an amount of steam, causing the coffee grounds to bloom. In certain embodiments, the vacuum-capable chamber 140 and the filter 160 can be implemented as a single unit so that the vacuuming of CO2 chemicals can be operated, as explained above, while the ground coffee from the grinder 134 is output and displaced in the filter 160 so that both vacuuming and blooming can occur in the filter 160. The filter 160 may be connected to an air inlet 155, facilitating introducing of air into the filter.

After blooming, water from the water tank 105 is poured on the coffee grounds. The coffee grounds mix with the heated water, allowing the coffee aromatics to mix with the water, resulting in coffee. The filter 160 allows the coffee to pass through to the pot 180, while retaining the coffee grounds.

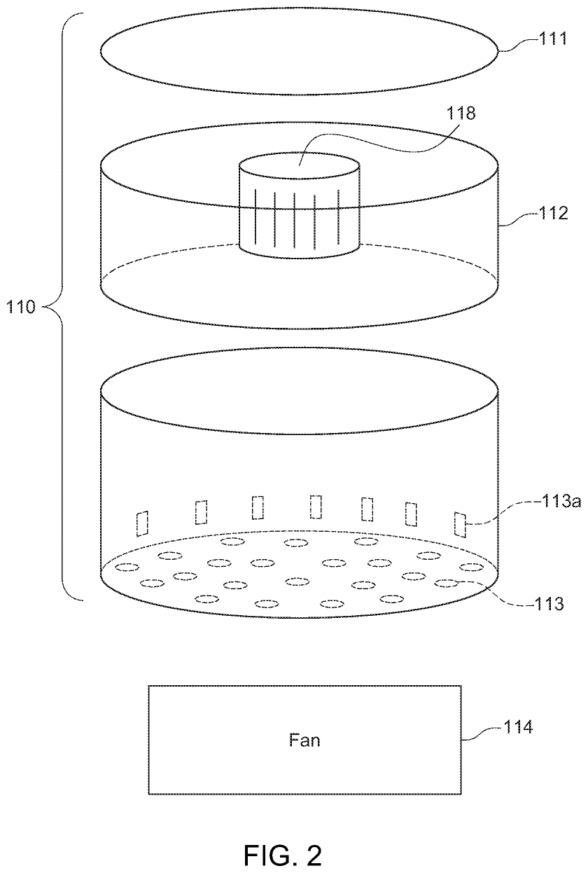

Referring to FIG. 2, there is illustrated a block diagram of an exemplary coffee roaster/cooler 110. For roasting green coffee beans, any conventional coffee roasting technique can be used according to the teachings of present invention. They may include, for example, centrifugal, tangential, drum, packed bed and hot air roasting technique. The roaster/cooler 110 can include a detachable cover 111, a removable peal filter or catcher 112, a cup 113 with a plurality of openings or a mesh bottom, and a plurality of vent openings 113a for facilitating the heat movement out of the roaster/cooler 110. Note that the plurality of vent opening can be provided on the top portion of the roaster/cooler 110. A fan 114, a heating element 115 and a heat exhaust (and/or exit chute) 116 are disposed under the roaster/cooler 110. In certain embodiments, the cup 113 can accommodate insertions of an amount of green coffee beans for a single serving (e.g., 6-7 green coffee beans for 1 cup/8 ounces/236 ml of coffee) to a group serving (e.g., approximately 50 green coffee beans for 8 cups/64 ounces/1.89 liters coffee). In certain embodiments, the cup 113 can be twice the stacked volume of 50 green coffee beans.

The green coffee beans can be placed into the roaster 110 by detaching the cover 111 and removing the peal filter 112, and placing the green coffee beans in the cup 113. In certain embodiments, the cover 111 and the peal filter 112 can be fit to one another, such that the cover 111 and the peal filter 112 can be removed simultaneously. It should be noted that in other embodiment, the cover 111 and the peal filter 112 can be implemented as a single unit.

The fan 114 is disposed directly under the openings or mesh bottom of the cup 113. The heating elements 115 comprising, for example, heating coils generate heat and heat the air proximate to the heating elements 115. The heat source may be from a wide range including electricity, wood, natural gas or petroleum gas. The fan 114 is configured to blow through the openings or mesh bottom of the cup 113 causing the air heated by the heating elements 115 to heat the green coffee beans fast and toss the green coffee beans evenly about the roaster 110. The speed of fan 114 can be adjusted to be increased or lowered to adjust for the beans becoming lighter during the roasting process, in order to prevent the beans from chipping. The fan speed can be also selectively controlled by a user for fine tuning roasting of the beans according to user's liking.

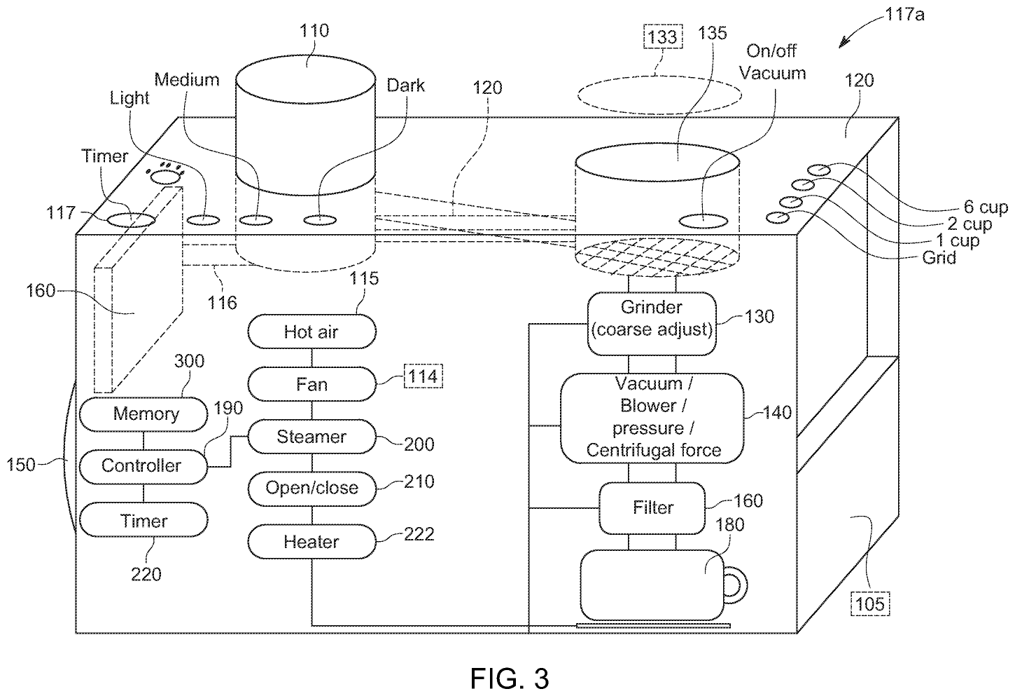

The roaster 110 can be easily controlled to heat the green coffee beans for a user selectable period of time, and may also be fully adjustable for users, including experienced roasters. As such, the roaster 1110 may be capable of roasting any kind of coffee including expresso beans. The user selectable period of time can be based on desired levels of roasting the green coffee beans, such as light roast, medium roast, and dark roast. As seen in FIG. 3, buttons 117a allow the user to input the desired level of roasting, fan speed and a coarseness adjustment. The user can further use the buttons 117a to adjust the preprogrammed roasting time, and control fan speed to obtain a desired level of roasting. Buttons 117a can, for example, allow the serving size and an option buttons for selectively turning the vacuum and grind procedures on and off.

Returning to FIG. 2, during the roasting, the pealing of the green coffee beans will separate from the rest of the coffee bean. In certain embodiments, the peal filter 112 can include, for example, a catcher 118 disposed around the circumference thereof and defining an opening in the center to accommodate entry of the peals into the peal filter 112, but inhibit the peals from exiting.

The roaster 110 may generate a considerable amount of heated air. In some embodiments, the detachable cover 111 and removable peal filter 112 may channel the air through vents in the detachable cover 111. In other embodiments, as seen in FIGS. 1 and 3, the detachable cover 111 and peal filter 112 may direct the air through a heat exhaust 116, so that the smell associated with the roasting can be filtered via the filter 160 and finally exit through an air outlet 150. Any of the roaster 110 components or its surface materials, including the detachable cover 111 and peal filter 112, can be made with a heat resistant rubber type material so as to reduce the noise associated with whole beans colliding against the surface or between the beans during roasting.

Referring to FIG. 1, the heat exhaust 116 may direct the air through a High Efficiency Particulate Air (HEPA) filter 160 to eliminate unwanted smells during roasting process and air outlet 150. It should that the HEPA filter 160 coupled to the air outlet 150 can be placed at any side of the coffee roaster and degasser 100. The HEPA filter 160 coupled to the air outlet 150 prevents any odor generated from the roasting to escape from the coffee roaster and degasser 100.

Returning to FIG. 1, at the end of the user selected period of time for roasting, a next cycle of cooling begins in the roaster/cooler 110. In an alternate embodiment where the cooler 110 is provided separately, an exit chute (not shown) provided at the bottom of the roaster 110 opens allowing the roasted coffee beans to pass through a tunnel to the grinder 130. The exit chute can be a retractable door of the same material as the bottom of the roaster 110. The stir mixer 109 can be provided to push all the roasted beans into the exit chute. Alternatively, the bottom of the roaster 110 can be tilted at an angle that causes the roasted coffee beans to enter into a tunnel leading to the grinder/130.

In an alternate embodiment, as shown in FIG. 3, the roaster 110 and cooler 135 can be disposed in a side-by-side arrangement, thereby keeping the coffee roaster and degasser 100 below a certain height and suitable for placement on countertops. In other embodiments, where the height of the coffee roaster and degasser 100 is not an issue, the cooler 135 could be disposed directly under the roaster 110. The exit chute could be disposed at the bottom so that the roasted coffee beans could fall into the cooler 135.

In another embodiment, the roaster 110 can also cool the roasted coffee beans. After roasting the green coffee beans, the heating element 115 can be turned off, while the fan continues to operate, blowing ambient air through the bottom of the roaster 110.

Referring again to FIG. 3, the roaster/cooler 135 can include openings in the cup 113 (or a mesh) at the bottom and a cooling fan 114. The cooling fan 114 can be disposed below the openings or mesh of the cup 113. The cooling fan 114 cools the roasted coffee beans from roasting temperature to near room temperature (77 degrees F./25 degrees C.). According to certain embodiments, the roaster/cooler 110 can cool the roasted coffee beans for 30 seconds-1 minute. After the roaster/cooler 110 cools the roasted beans, an opening below the roaster/cooler 110 drops the roasted beans into the grinder 130. The grinder 130 grinds the roasted coffee beans into ground coffee.

Referring to FIG. 3, in an alternate embodiment, the cooler 135 can also include a removable cover 133 and be positioned to be exposed to the exterior of the coffee roaster and degasser 100. In alternate embodiment, the user can store the roasted coffee beans received from the roaster 110 in the cooler 135 for a desired amount of time, such as for example, one to two days for degassing at room temperature. In this case, the vacuum procedure can be optionally skipped. The cooler 135 can be used to receive pre-roasted coffee beans. Alternatively, referring to FIG. 1, the pre-roasted coffee beans can also be dropped into the roaster/cooler 110. In this case, the vacuum procedure can be optionally skipped.

In the above both embodiments, the pre-roasted coffee beans can be dropped into the grinder 130 without performing any roasting and cooling operations. As a result, the pre-roasted coffee beans from another vendor or any purchased pre-roasted coffee beans can be used for a regular grinding and brewing capabilities provided by the coffee roaster and degasser 100.

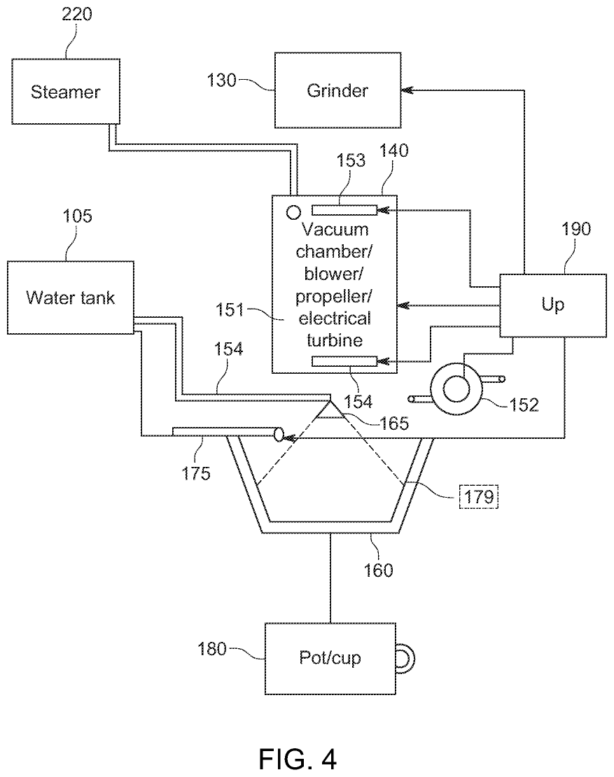

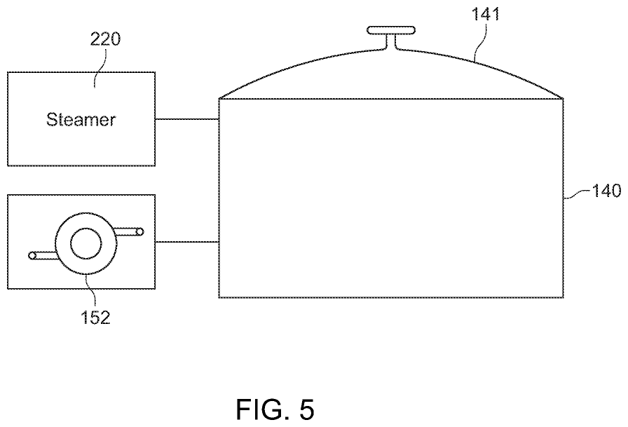

Referring to FIGS. 1 and 4, the grinder 130 drops the ground coffee into the vacuum-capable chamber 140. As seen in FIG. 4, the vacuum-capable chamber 140 includes a hollow 151, and vacuum pump 152. The hollow 151 includes a top retractable opening 153 and a bottom retractable opening 154. The grinder 130 drops the ground coffee into the hollow 151 through the top retractable opening 153. The top retractable opening 153 closes after receiving the ground coffee. The vacuum pump 152 removes the air from the hollow 151, including carbon dioxide released by the ground coffee by the application of negative-pressure vacuum. It should be noted that the vacuum-capable chamber 140 can be implemented as a separate unit according another embodiment so that a user can speed up the degassing of any roasted beans or ground coffee to enjoy their coffee. That is, a separate unit containing the steamer 200 and/or the vacuum-capable chamber 140 including the vacuum pump 152 can be assembled in a housing to perform the degassing operation only. FIG. 5 illustrates such an embodiment in which the vacuum-capable chamber 140 may include a cover 141 to place the roasted bean or ground coffee from another source. For example, the user may prefer roasting his coffee using a pop corn machine, oven, or using a pan at home but wishes to speed up the degassing process for faster consumption and better taste. To this end, the user can use an illustrative apparatus shown in FIG. 5 in which the teachings of present invention is implemented for degassing purpose.

The vacuum pump 152 can vacuum the air out of the hollow 151 for a predetermined time, such as 30 seconds to 1 minute. In certain embodiments, this can be set by the user. In another embodiment, the vacuum pump 152 can increase the vacuum and decrease the vacuum at constant or variable intervals to cause a pressure difference during vacuum operation which in turn would cause CO2 gas to move out of the ground coffee. During vacuum operation, the steamer 200 may generate steam to be applied to the ground coffee in the vacuum-capable chamber 140 to exert the molecules of ground coffee to enhance degassing process.

After vacuuming the ground coffee, the vacuum 140 releases the ground coffee into the filter 160. In certain embodiments, the vacuuming step can be skipped by keeping open both the top retractable opening 153 and the bottom retractable opening 154, allowing the ground coffee to drop directly into the filter 160. For example, the vacuum-capable chamber 140 can be configured to periodically self-test the vacuum pump 152 and detect for leaks using a vacuum-pressure sensor. When the vacuum pump 152 is found to be malfunctioning, the vacuum 140 can keep both the top retractable opening 153 and bottom retractable opening 154 open. As an another example, if the user wishes to use already pre-roasted coffee beans, then the roasting operation and the vacuum operation can be skipped.

As previously described, the vacuum-capable chamber 140 may be implemented as to incorporate other types of treatment of the ground coffee. In certain embodiments, the vacuum-capable chamber 140 may be equipped with a centrifuge in order to spin the coffee grounds at high speeds, which may aid degassing in combination with the application of steam, and/or vacuum. The application of centrifugal spinning combined with the other techniques indicated herein may speed the degassing of the ground coffee beans.

The vacuum-capable chamber 140 may be equipped with a blower in order to introduce the movement of air over the ground coffee. The blowing of air over the ground coffee may trigger additional degassing, which may speed up the degassing process when used in combination or sequence with one or more of the application of steam, vacuum, and/or centrifugal spinning

The vacuum-capable chamber 140 may be implemented as to withstand positive internal pressure, and be equipped with an air pressurizer to generate positive pressure within the vacuum-capable chamber. Application of positive-pressure to the ground coffee may aid degassing in combination and/or sequence with one or more of the application of steam, vacuum, centrifugal spinning and positive pressure. It is understood any combination or sub-combination of these processes may be utilized, and any sequence of the combination or sub-combination may be utilized in order to achieve the desired result.

Referring against to FIG. 4, the filter 16 can include a reusable filter or paper filter 179 and nozzle 165. The nozzle 165 is configured to spray a predetermined amount of water from the water tank 105 on the ground coffee substantially evenly or uniformly, or with no more than 10% variance. The predetermined amount of water can be an amount determined to cause the amount of ground coffee to bloom. For example, the predetermined amount of water can be approximately 1.5 ounces/42 grams per single cup serving. After a predetermined time, for example 30 seconds to 1 minute, a pipe 175 pours water from the water tank 105 over the ground coffee in the amount of a user selected server (such as 6-8 ounces/170 ml-226 ml) per serving. The water mixes with the aromatics in the ground coffee, resulting in coffee. In certain embodiments, such as an espresso machine, the nozzle 165 and the pipe 175 can provide steam. The filter 160 retains the ground coffee while allowing the coffee to drop into the pot 180.

Referring back to FIG. 3, certain embodiments can include one or more processors 190, coupled to a memory 300, for controlling the coffee roaster and degasser 100. The one or more processors 190 can receive inputs from buttons 117a and can control the fan 114, opener and closer 210, heating elements 115, steamer 200, exit chute 116, cooling fan 114, grinder 130, vacuum pump 152, heater 222, the top retractable opening 153 and bottom retractable opening 154 of the vacuum-capable chamber 140, nozzle 165, and pipe 175 (as seen in FIG. 4). The one or more processors 190 control the foregoing by use of an internal timer 220 and transmitting an enabling control signals that can, for example, control whether the foregoing components receive electrical power.

The control unit may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc.

In certain embodiments, the roaster 110 can both roast the green coffee beans and cool the roasted coffee beans. In the foregoing case, the cooler 135 can be omitted, and the roasted coffee beans can enter the grinder 130 directly from the exit chute.

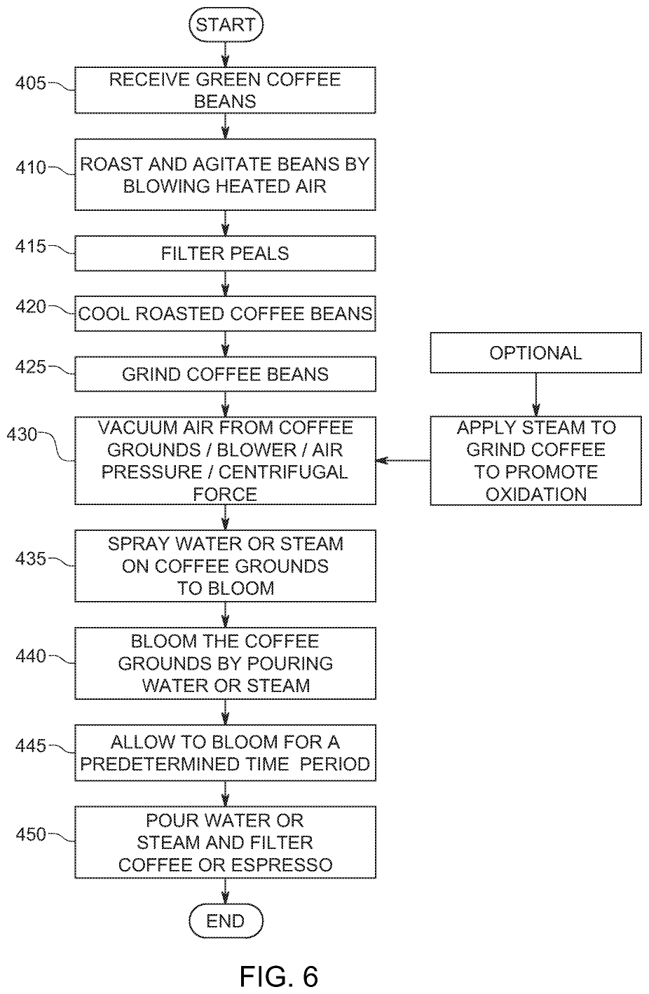

FIG. 6 is a block diagram of a method for preparing coffee. The method comprises receiving green coffee beans at 405. The green coffee beans can be received by the roaster/cooler 110 or 130. At 410, the roaster 110 roasts and agitates the green coffee beans by blowing heated air by the fan 114. The heating elements 115 generate heat that heats the air proximate to the heating elements 115. The fan 114 blows the heated air through the bottom openings or mesh bottom of the cup 113 causing the green coffee beans to be tossed within the roaster 110. Meanwhile the heated air during roasting can exit via the plurality of vent openings 113a which in turn will be circulated through the filter 160 for removing burnt roasted odor and finally exit via the air outlet 150. While being tossed during 410, the peals separate from the remainder of the bean and blown into filter 112. The result of 410 and 415 are roasted coffee beans.

At 420, the roasted coffee beans are cooled. The roasted coffee beans can be cooled by either cooler (not depicted) at a location lateral to the roaster 110, a cooler 135 directly below the roaster 110, or in the roaster itself 110. If the roasted coffee beans are roasted in the cooler 135 or roaster 110, fan 114 blows air to cool the roasted beans. If the roasted coffee beans are cooled in the roaster 110, the heating elements 115 are turned off, and the fan 114 blows ambient temperature air through the bottom opening or mesh of the cup 113.

At 425, the grinder 130 grinds the roasted coffee beans, resulting in coffee grounds. The hollow 151 receives the coffee grounds by opening the top retractable opening 153 and closing.

At 430, the vacuum pump 152 vacuums the air from the hollow 151 for predetermined time such as 30 sec.-1 minute. Alternatively, the air pressure can be varied by increasing and decreasing the vacuum at a constant or variable level. Prior to vacuuming or during vacuuming, a steam can be applied to the ground coffee to promote oxidation. After the vacuum pump 152 vacuums the air, the bottom retractable opening 154 opens causing the coffee grounds to drop into the filter 160. As noted above, the vacuum chamber may also be equipped with a centrifuge, blower and/or air pressurizer, in order to apply one or more of centrifugal spinning, moving air or positive air pressure to the ground coffee, in tandem or in sequence with the application of negative-pressure vacuum. It is understood that any combination, and sub-combination may be utilized, in any desired sequence or cotemporaneous applications.

At 440, nozzle 165 sprays water or steam onto the coffee grounds causing the coffee grounds to bloom. After a predetermined period of time (445), such as 30 seconds, at 450 the pipe 175 pours water or steam onto the coffee grounds and filters coffee or expresso. The water or vaporized steam mixes with the coffee grounds resulting in coffee or espresso. The filter 160 retrains the coffee grounds and permits the coffee or espresso to drop into the pot 180.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA.

As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A coffee roaster and degasser, comprising:
a roaster configured to roast green coffee beans, thereby resulting in roasted coffee beans;
a grinder configured to grind the roasted coffee beans, thereby resulting in ground coffee; and
a degassing stage configured to degas carbon dioxide from the ground coffee.

2. The coffee roaster and degasser of claim 1, wherein the degassing stage comprises a vacuum.

3. The coffee roaster and degasser of claim 2, wherein the degassing stage comprises a bloomer disposed below the vacuum.

4. The coffee roaster and degasser of claim 1, wherein the roaster is configured to cool the roasted coffee beans.

5. The coffee roaster and degasser of claim 1, further comprising a cooler configured to receive the roasted coffee beans from the roaster, and cool the roasted coffee beans, and provide the roasted coffee beans to the grinder.

6. The coffee roaster and degasser of claim 5, wherein the cooler is disposed under the roaster.

7. The coffee roaster and degasser of claim 5, wherein the cooler is disposed laterally relative to the roaster, and wherein the roaster and the cooler are connected by a tunnel.

8. The coffee roaster and degasser of claim 1, wherein the roaster comprises:
a heating element configured to generated heat;
a fan configured to blow air heated by the heating element and cause the green coffee beans to be tossed about the roaster;
a filter for catching peals of the green coffee beans.

9. The coffee roaster and degasser of claim 8, further comprising:
an exhaust connected to the roaster to divert air heated by the heating element; and
a high-efficiency particular air (HEPA) filter disposed below the exhaust.

10. The coffee roaster and degasser of claim 8, wherein the roaster is configured to cool the roasted coffee beans, and
wherein when the roaster roasts the green coffee beans, the heating element generates heat and the fan blows air heated by the heating element, and when the roaster reduces a temperature of the roasted coffee beans, the heating element is off, and the fan blows ambient air.

11. The coffee roaster and degasser of claim 3, wherein the bloomer comprises:
a filter configured to receive the coffee grounds;
a nozzle configured to spray a predetermined amount of water on the coffee grounds in the filter; and
a pipe configured to pour water on the coffee grounds for a predetermined period of time after the nozzle sprays the predetermined amount of water, thereby resulting in coffee; and
wherein the filter permits the coffee to pass through while inhibiting the coffee grounds.

12. The coffee roaster and degasser of claim 3, wherein the bloomer comprises:
a filter configured to receive the coffee grounds;
a nozzle configured to provide steam to the coffee grounds in the filter; and
a pipe configured to provide steam to the coffee grounds for a predetermined period of time after the nozzle provides steam, thereby resulting in espresso; and
wherein the filter permits the espresso to pass through while inhibiting the coffee grounds.

13. The coffee roaster and degasser of claim 2, further comprising a steamer to apply steam to the grounded coffee before applying the vacuum.

14. The coffee roaster and degasser of claim 2, wherein the degassing stage comprises at least one of:
modulating a degree of negative pressure in the vacuum at a constant or variable interval; and
modulating between negative pressure in the vacuum and positive pressure at a constant or variable interval.

15. The coffee roaster and degasser of claim 1, wherein the degassing state comprises a vacuum chamber in which negative-pressure is applied to the ground coffee to accelerate degassing.

16. The coffee roaster and degasser of claim 1, wherein the vacuum chamber includes a centrifuge such that ground coffee disposed within the vacuum chamber is centrifugally spun in sequence with the application of the negative-pressure vacuum to accelerate degassing.

17. The coffee roaster and degasser of claim 1, wherein the vacuum chamber includes a blower configured to generate a flow of air cover the coffee grounds in sequence with the application of the negative-pressure vacuum to accelerate degassing.

18. The coffee roaster and degasser of claim 1, wherein the vacuum chamber is configured to sustain positive air pressure, and includes an air pressurizer to apply positive air pressure to the ground coffee disposed within the vacuum chamber in sequence with the application of the negative-pressure vacuum to accelerate degassing.

19. A method for preparing coffee, said method comprising:
roasting green coffee beans, thereby resulting in roasted coffee beans;
grinding the roasted coffee beans, thereby resulting in ground coffee; and
degassing carbon dioxide from the ground coffee.

20. The method of claim 19, wherein the degassing the carbon dioxide from the ground coffee comprises disposing the coffee grounds into a vacuum chamber, and vacuuming air from the vacuum chamber.

21. The method of claim 19, wherein the degassing the carbon dioxide further comprises:
receiving the coffee grounds from the vacuum; and
blooming the coffee grounds.

22. The method of claim 19, cooling the roasted coffee beans at a location where the coffee beans are roasted.

23. The method of claim 19, further comprising cooling the roasted coffee beans at a location directly below a location where the green coffee beans are roasted.

24. The method of claim 19, further comprising cooling the roasted coffee beans at a location lateral to a location where the green coffee beans are roasted.

25. The method of claim 19, wherein the roasting the green coffee beans comprises:
blowing air heated by a heating element by a fan and causing the green coffee beans to be agitated; and
filtering peals of the green coffee beans.

26. The method of claim 25, further comprising:
diverting the air heated by the heating element; and
filtering the air heated by the heating element with a HEPA filter.

27. The method of claim 25, further comprising cooling the roasted coffee beans by turning the heating element off and blowing ambient air by the fan.

28. The method of claim 21, wherein blooming comprises:
receiving the coffee grounds in a filter; and
spraying water on the coffee grounds in the filter causing the coffee grounds to bloom;
pouring water on the coffee grounds after the coffee grounds bloom, thereby resulting in coffee; and
allowing the coffee to pass through the filter while retaining the coffee grounds.

29. The method of claim 21, wherein blooming comprises:
receiving the coffee grounds in a filter; and
spraying steam on the coffee grounds in the filter causing the coffee grounds to bloom;
pouring steam on the coffee grounds after the coffee grounds bloom, thereby resulting in espresso; and
allowing the espresso to pass through the filter while retaining the coffee grounds.

30. The method of claim 19, wherein the degassing the carbon dioxide from the ground coffee comprises disposing the coffee grounds into a vacuum chamber and vacuuming air from the vacuum chamber by increasing the vacuum and decreasing the vacuum at constant or variable intervals.

31. The method of claim 19, wherein the degassing the carbon dioxide from the ground coffee further comprises disposing the coffee grounds into a vacuum chamber and applying a steam to the coffee grounds.

32. The method of claim 19, wherein degassing the ground coffee includes disposing the ground coffee in a vacuum chamber and evacuating air from the vacuum chamber to apply negative-pressure vacuum to the coffee grounds

33. The method of claim 32, wherein the vacuum chamber includes a centrifuge, and degassing the ground coffee includes actuating the centrifuge to centrifugally spin the coffee grounds in sequence with the application of the negative-pressure vacuum to accelerate degassing.

34. The method of claim 32, wherein the vacuum chamber includes a blower, and degassing the ground coffee includes actuating the blower to generate a flow of air over the coffee grounds in sequence with the application of the negative-pressure vacuum to accelerate degassing.

35. The method of claim 32, wherein the vacuum chamber is configured to sustain positive air pressure, and includes an air pressurizer, and degassing the ground coffee includes applying positive air pressure to the coffee grounds disposed within the vacuum chamber in sequence with the application of the negative-pressure vacuum to accelerate degassing.
